(19) United States
(12) Patent Application Publication
(10) Pub. No.: US 2025/0382224 A1
(43) Pub. Date: Dec. 18, 2025

(54) SYSTEM AND METHOD FOR CROSSLINKING A CONTINUOUS MAT OF MINERAL AND/OR PLANT FIBERS

(71) Applicant: SAINT-GOBAIN ISOVER, COURBEVOIE (FR)

(72) Inventors: Bernard BAUDOUIN, COURBEVOIE (FR); Michael CHARREL, CHALON-SUR-SAÖNE (FR)

(21) Appl. No.: 18/876,954

(22) PCT Filed: Jun. 20, 2023
(86) PCT No.: PCT/EP2023/066574

§ 371 Date: Dec. 19, 2024

(30) Foreign Application Priority Data
Jun. 20, 2022 (FR) 2206039

(51) Int. Cl. C03C 25/002; C03B 37/04; C03C 25/1095; C03C 25/14; F27D 11/02; F27D 17/17

(52) U.S. Cl. CPC C03C 25/002; C03C 25/1095; F27D 11/02; F27D 17/17; C03B 37/04; C03C 25/14

(57) ABSTRACT

A system for crosslinking a continuous mat of mineral and/or plant fibers, includes a crosslinking oven for the mat including at least one heating box, each heating box being connected to a combustion chamber. The crosslinking system further includes an injection system arranged outside the crosslinking oven and configured to inject hot air into at least one combustion chamber of a heating box, the hot air thus injected replacing a given fraction of hot air produced by at least one burner attached to the said at least one combustion chamber.

### PRIOR ART

The present invention belongs to the general field of manufacturing thermal and/or acoustic insulation products. More particularly, it relates to a system for crosslinking a continuous mat of mineral and/or plant fibers, in particular mineral wool, of the glass or rock wool type. Such a mat is intended to be cut in order to form, for example, thermal and/or acoustic insulation panels or rolls. The invention also relates to a crosslinking method implemented by means of such a crosslinking system.

Conventionally, the manufacture of such insulating fiber mats primarily comprises fiberizing and depositing fibers on a perforated moving conveyor or transporter. The newly-formed fiber mass is pressed onto the conveyor using suction boxes arranged under the transporter on which they are deposited. During fiberizing, a binder is sprayed in solution or suspension state in a volatile liquid such as water onto the drawn fibers, this binder having adhesive properties and usually comprising a hot-curable material, such as a thermosetting resin.

The primary layer of relatively loose fibers on the collecting conveyor is then transferred to a heating device commonly called a crosslinking oven in the field in question. The continuous mat of fibers passes through the full length of the oven, thanks to conveyors that face one another, pressing the mat between them, and whose distance apart is adjustable. Such a mat thus has a greater or lesser density depending on the degree of compression exerted by the two conveyors in the oven.

During its passage in the oven, the mat is simultaneously dried and subjected to a specific heat treatment which causes the polymerization (or “curing”) of the thermosetting resin of the binder present on the surface of the fibers.

The procedure used to cause the curing of the binder consists in passing heated air through the whole thickness of the mat, in such a way that the binder present throughout the thickness of the mat is brought progressively to a temperature above its curing temperature.

To this end, the crosslinking oven consists of an enclosure forming a closed chamber wherein a series of boxes are arranged. Each box is supplied with hot air by a combustion chamber to which at least one burner is attached, and fans to supply air to the said at least one burner and to circulate the hot air produced by the burner.

Each box thus defines an independent heating zone, wherein specific heating conditions are set. The boxes are separated by walls having openings for the mat and the upper and lower conveyors. The use of a plurality of boxes thus advantageously allows a graduated elevation and better control of the temperature of the mat throughout its passage through the oven and prevents the appearance of hot spots due to locally excessive heating or, alternatively the presence within the mat of zones wherein the binder would not have been entirely polymerized.

In practice, the operation and use of a crosslinking oven are subject to various constraints. Among these constraints, operating safety is a key one, and constitutes a regulatory framework that is binding on every operator. In particular, a number of risks need to be controlled, including the risk of heat build-up within the oven, as well as the explosive risk associated with the production of flammable substances (such as volatile organic compounds) during crosslinking operations.

In addition to these traditional safety constraints, there are now other constraints. The crosslinking ovens used to date consume a significant amount of energy. The energy consumed comes almost entirely from the gas required by the burners to supply hot air to the heating chambers. The manufacture of insulating fiber mats is therefore a particularly high emitter of greenhouse gases, typically such as CO2, which is problematic not only in terms of environmental protection, but also in terms of controlling production costs (gas prices can fluctuate widely).

### OVERVIEW OF THE INVENTION

The aim of the present invention is to remedy some or all of the disadvantages of the prior art, in particular those set out above, by proposing a solution that makes it possible to safely manufacture an insulating fiber mat while reducing the amount of gas consumed compared with solutions in the state of the art, and while maintaining excellent energy efficiency. In particular, the present invention makes it possible to meet current environmental protection requirements by offering the possibility of limiting greenhouse gas emissions during the manufacture of an insulating fiber mat.

To this end, and according to a first aspect, the invention relates to a system for crosslinking a continuous mat of mineral and/or plant fibers, comprising an oven for crosslinking said mat comprising at least one heating box, each heating box being connected to a combustion chamber. The said crosslinking system also comprises an “injection” system arranged outside the crosslinking oven and configured to inject hot air into at least one combustion chamber of a heating box, the hot air thus injected replacing a given fraction of hot air produced by at least one burner attached to said at least one combustion chamber.

The plant fibers are preferably selected from the group consisting of lignocellulosic fibers and cotton fibers. The lignocellulosic fibers are preferably selected from wood fibers, hemp fibers, flax fibers, sisal fibers, cotton fibers, jute fibers, coconut fibers, raffia fibers, abaca fibers, cereal straw or rice straw.

In this way, the hot air injected into a combustion chamber by means of the injection system replaces part of the hot air that would be produced (nominally) by at least one burner without external energy input (that is, the hot air circulating in a heating box and produced exclusively from gas used by at least one burner, or put another way, the hot air produced by at least one burner before the injection system is put into operation).

Note that for the purposes of the present invention, the term “fraction” refers to a fraction strictly less than 100%. Put another way, the invention is implemented by ensuring that the burner(s) in each heating box designed to receive hot air from the injection system continue to operate. Such arrangements are advantageous since the preservation of a burner flame avoids any explosive risk associated with an accumulation of flammable gases.

The choice of the value of said fraction may depend on how the crosslinking system is to be operated. As a non-limiting example, the value of the fraction can be set so that the flow of hot air injected via said injection system replaces (substitutes for) part of the nominal flow of hot air circulating within said at least one heating box. Of course, the control of the injection system, and therefore a fortiori the choice of the value of said fraction, can be carried out according to still other considerations, such as, for example, considerations in terms of energy or power supplied by at least one burner of said at least one heating box (that is, the aim is to replace (substitute) part of this energy/power thanks to the hot air injected with the injection system).

Generally speaking, the crosslinking oven's operational safety is guaranteed by the supply of hot air that sweeps through the heating chamber(s).

In addition, by supplying hot air from outside the crosslinking oven, the invention offers the advantageous possibility of limiting gas consumption, and therefore ultimately of limiting greenhouse gas emissions (e.g., hot air produced from “green” electricity, that is, electricity produced from energy with low CO2 emissions, such as renewable energies or nuclear energy).

In particular, the inventors estimated that the gas requirement of a crosslinking oven could be reduced by 50% to 70% thanks to the invention, resulting in a substantial amount of greenhouse gases not being released into the atmosphere.

The inventors also found that this substitution of part of the gas by hot air produced by the injection system had a very low impact on the energy efficiency generally obtained during mat manufacture (typically a drop of 3% to 4% essentially due to heat losses at the walls between the injection system and the crosslinking oven).

A further advantage of the invention lies in the fact that the injection system can be easily installed on an existing enclosure. For example, the injection system can be positioned on the floor next to the crosslinking oven enclosure, or at height, for example on a dedicated walkway.

What's more, the external position of the injection system protects it from any pollution (e.g., release of particles) generated by the crosslinking oven, as such pollution could cause clogging that would be fatal to its operation.

In particular embodiments, the crosslinking system may further include one or more of the following features, taken alone or in any technically feasible combinations.

In particular embodiments, said fraction is between 2% and 40%, for example between 5% and 30%, more particularly between 5% and 20%, or even between 7% and 20%, or preferentially between 5% and 15%, even more preferentially between 10% and 15%.

In particular embodiments, the injection system comprises heating means, for example electric heating means, configured to heat ambient air to a given temperature.

In particular embodiments, said given temperature is between 350° C. and 1000° C., for example between 500° C. and 1000° C., more particularly between 700° C. and 800° C., even more particularly substantially equal to 750° C.

In particular embodiments, the heating means comprise at least one electric battery with a power rating of between 100 kW and 900 kW, more particularly between 500 kW and 700 kW, for example substantially equal to 600 kW.

In particular embodiments, the injection system is supplied with preheated air.

In particular embodiments, at least some of the preheated air comes from a glass melting furnace and/or corresponds to hot recovery air.

In particular embodiments, the injection system is connected to a hot air emergency exhaust positioned between said injection system and said crosslinking oven.

In particular embodiments, the injection system is configured to inject hot air from outside the crosslinking oven.

In particular embodiments, the injection system comprises a hot air supply line between a hot air source outside the crosslinking oven and the at least one combustion chamber.

According to a second aspect, the invention concerns a line for manufacturing a continuous mineral and/or plant fiber mat, comprising a unit for fiberizing a continuous mineral and/or plant fiber mat, a conveyor for transporting the mat, and a crosslinking system according to the invention.

According to a third aspect, the invention concerns a method for crosslinking a continuous mat of mineral and/or plant fibers, said method being implemented by means of a crosslinking system according to the invention.

According to a fourth aspect, the invention concerns a method for manufacturing a continuous mat of mineral and/or plant fibers, said method being implemented by means of a manufacturing line according to the invention.

### BRIEF DESCRIPTION OF THE DRAWINGS

Other features and advantages of the present invention will emerge from the non-limiting description given below, with reference to the appended drawings that illustrate an exemplary embodiment thereof. In the Figures:

FIG. 1 shows schematically, in its environment, a particular embodiment of a manufacturing line for a continuous mineral fiber mat according to the invention;

FIG. 2 shows schematically a particular embodiment of a crosslinking system according to the invention belonging to the manufacturing line of FIG. 1.

### DESCRIPTION OF EMBODIMENTS

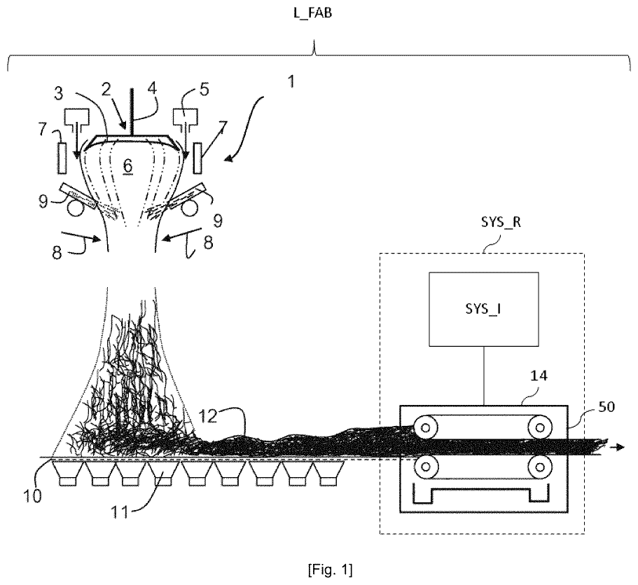

FIG. 1 schematically depicts, in its environment, a particular embodiment of an L_FAB manufacturing line according to the invention.

The L_FAB manufacturing line is configured for the manufacture of a continuous mineral fiber mat, more particularly based on glass wool, it being understood that the L_FAB line is of any type suitable for the production of products based on mineral and possibly plant fibers. The first steps in manufacturing said mat are also described with reference to FIG. 1.

Conventionally, the L_FAB manufacturing line comprises a drawing unit 1 configured to implement an internal centrifugal drawing process known per se. The fiberizing unit 1 comprises a hood (not shown in FIG. 1) topped by at least one centrifuge 2. Each centrifuge 2 comprises a basket (not shown in FIG. 1) for collecting a thread of pre-melted fiber glass, and a plate-shaped part 3 whose peripheral wall is provided with a large number of orifices.

In operation, the molten glass, which is fed in a thread from a melting furnace (not shown) and first collected in the centrifuge basket, escapes through the plate orifices in the form of a multitude of rotating filaments. The centrifuge 2 is also surrounded by an annular burner 5 which creates at the periphery of the wall of the centrifuge 2 a gas stream at high speed and at sufficiently high temperature to draw the glass filaments into fibers in the form of a torus 6.

Heating means 7, such as inductor(s), are used to maintain the glass and centrifuge 2 at the right temperature. The torus 6 is closed by a gaseous stream of pressurized air, shown by arrows 8 in FIG. 1. The torus 6 thus created is surrounded by a sizing spray device containing a thermosetting binder in aqueous solution, of which only two elements 9 are shown in FIG. 1.

This may for example consist of a phenolic binder or an alternative binder with a low formaldehyde content, preferably even without formaldehyde, binders sometimes referred to as “green binders”, in particular when they are at least partially derived from a renewable raw material base, in particular a plant base, in particular of the type based on hydrogenated or non-hydrogenated sugars.

The bottom of the fiberizing hood is formed by a fiber-receiving device comprising a conveyor incorporating a gas- and water-permeable endless belt 10, beneath which are arranged suction boxes 11 for gases such as air, fumes and excess aqueous compositions from the previously described fiberizing process. A mat 12 of glass wool fibers intimately mixed with the sizing composition is thus formed on the conveyor belt 10. Mat 12 is conveyed by conveyor 10 to a SYS_R crosslinking system according to the invention.

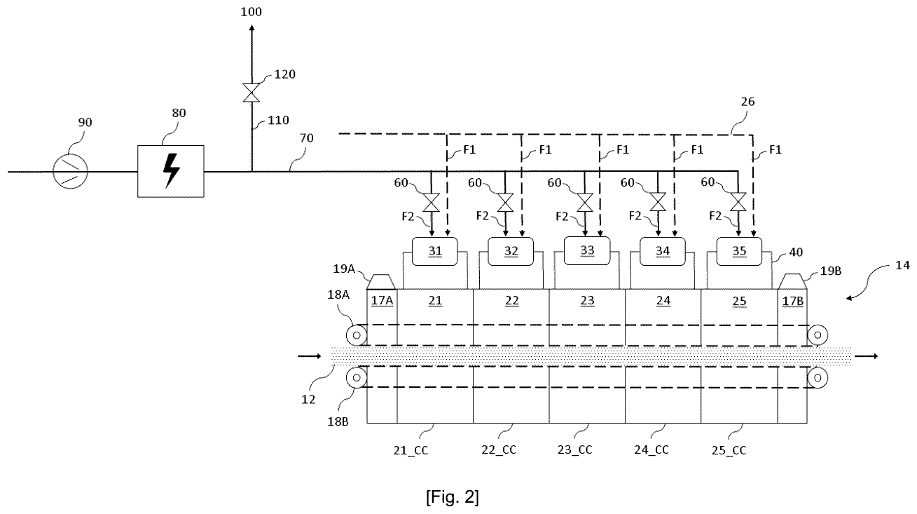

FIG. 2 shows schematically a particular embodiment of the SYS_R crosslinking system belonging to the L_FAB manufacturing line shown in FIG. 1.

As shown in FIG. 2, the SYS_R crosslinking system includes a crosslinking oven 14 for crosslinking the thermosetting binder. The crosslinking oven 14 comprises a series of heating boxes separated from one another by insulating walls.

More specifically, in the embodiment described here, the heating boxes 21-25 are five in number.

The use of a plurality of boxes enables the fiber mat 12 to be gradually heated to a temperature above the curing temperature of the binder present on the fibers of mat 12. The mechanical properties of the final product depend on perfect temperature control in the various boxes, especially if a green binder is used, as mentioned above.

The fact that five boxes are considered, however, does not constitute a limitation of the invention. Generally speaking, there are no restrictions on this aspect.

Each box 21-25 comprises a central compartment 21_CC-25_CC forming an enclosure of said box and surrounded by insulation material.

Two conveyors 18A, 18B for transporting and calibrating the mat 12 pass through the enclosure of each box 21-25. These conveyors 18A, 18B, for example, are set in rotation by motors placed on the ground (not shown in the Figures), and are formed in a well-known way by a succession of pallets consisting of grids hinged together and perforated to be permeable to gases.

While ensuring the passage of hot gases that promote the rapid setting of the binder, the conveyors 18A, 18B typically compress the mat 12 to the desired thickness.

As an example, for a rolled panel, this is typically between 10 and 450 mm, the density of the glass wool layer being for example between 5 and 150 kg/m3. A distinction is made, for example, between low-density products wherein the density varies between 5 and 20 kg/m3, and high-density products wherein the density varies between 20 and 150 kg/m3.

The mineral wool mat 12, sprayed with binder, first enters an inlet airlock 17A equipped with a fume extraction hood 19A, this hood 19A being connected to a dedicated fume treatment circuit (not shown in the Figures). In this first inlet airlock 17A, the hot air introduced into the mat 12 first vaporizes the residual water present in the fiber mat 12.

Additional fumes generated in the boxes 21-25 are generally discharged into an outlet airlock 17B, via a 19B hood.

It is important to note that considering hoods 19A and 19B arranged at the inlet and outlet of the SYS_R crosslinking system is only one variant implementation of the invention. Any other variant known to the person skilled in the art can be envisaged, such as a variant in which a hood is arranged substantially in the center of the crosslinking oven 14.

Conventionally, and as shown in FIG. 2, each heating box 21-25 is connected to (that is, is in fluid communication with) a combustion chamber 31-35. Each combustion chamber 31-35 supplies hot air to the associated heating box 21-25, this hot air being produced by a burner (not shown in FIG. 2) attached to said combustion chamber 31-35 (it being understood that the burner body is located outside the combustion chamber) and circulated by means of fans (not shown in FIG. 2).

It should be noted that it is assumed here that each combustion chamber 31-35 is equipped with a single burner. Of course, these provisions are by no means limitative of the invention, as each combustion chamber 31-35 can be equipped with one or more burners, as is well known to the person skilled in the art.

Each burner is supplied with gas and combustion air from a gas line 26, so as to produce hot air intended for the heating box 21-25 connected to the combustion chamber 31-35 with which said burner cooperates. This gas supply is symbolized in FIG. 2 by arrows F1.

As a non-limiting example, the setting temperature of a combustion chamber 31-35 is between 200° C. and 250° C. (or even up to 300° C.), for example equal to 210° C., 215° C., 225° C., etc.

In the embodiment described with reference to FIG. 2, each heating box 21-25 has a hot air recirculation circuit in fluid communication with the combustion chamber 31-35. This recirculation circuit is, for example, envisaged in cooperation with at least one radial turbine suitable for drawing in hot air and/or with additional heating means positioned within the enclosure 31-35 of the heating box 21-25. Such an implementation is, for example, described in detail in document WO2016203170. Note that only part of the recirculation circuit is shown in FIG. 2 in the form of a recirculation duct 40.

Although it is assumed here that hot air circulation is achieved by means of a recirculation circuit, it is important to note that this is only one variant implementation of the invention. However, this does not preclude the possibility of other embodiments, such as those wherein hot air is introduced into a heating box 21-25 from below (or above) and discharged from above (or below), with hot air circulation within the heating box 21-25 being achieved by a system of inlet and outlet hoods. Such an implementation is also described in the aforementioned document WO2016203170.

Conventionally, the crosslinking oven 14 comprises an outer insulating jacket 50 (only shown in FIG. 1 for clarity of representation) surrounding all the boxes 21-25, made of an insulating material such as mineral wool. In most cases, this outer insulating envelope 50 itself surrounds a first metal enclosure (not shown in the Figures) to ensure the sealing of the entire installation so that polluted gases can only be discharged from the device via the hoods 19B and 19A.

In accordance with the invention, the SYS_R crosslinking system comprises, in addition to the crosslinking oven 14, a so-called “injection” system SYS_I arranged outside said oven 14.

By “arranged outside the oven 14”, it is meant that the injection system SYS_I is positioned outside the enclosure 50 of the oven 14.

Basically, there is no limitation to the location of the system SYS_I, as long as it is located outside the oven 14. For example, the system SYS_I can be positioned on the floor next to the enclosure of the oven 14, or at height, for example on a dedicated walkway.

The injection system SYS_I is configured to inject hot air into at least one combustion chamber 31-35 (and therefore a fortiori into at least one heating box 21-25), the hot air thus injected replacing a given fraction of hot air produced by the burner attached to (cooperating with) said at least one combustion chamber 31-35.

In other words, the hot air injected into a combustion chamber 31-35 by means of the system SYS_I replaces part of the hot air nominally produced by the burners (that is, by “nominally”, we refer here to a situation wherein the hot air circulating in a heating box 21-25 is produced exclusively from the gas used by the burners).

More particularly, in the embodiment described here, the fraction value is set so that the hot air flow rate injected via said injection system SYS_I replaces (substitutes for) a given portion of the nominal hot air circulation flow rate within said at least one heating box 31-35.

Note that for the purposes of the present invention, the term “fraction” refers to a fraction strictly less than 100%. Put another way, the invention is implemented by ensuring that the burner of each heating box 21-25 designed to receive hot air from the system SYS_I continues to operate. Such arrangements are advantageous since the preservation of a burner flame avoids any explosive risk associated with an accumulation of flammable gases.

The hot air of the SYS_I injection system can, for example, be injected so that the said fraction is between 2% and 40%, according to a more specific example between 5% and 30%, more particularly between 5% and 20%, or even between 7% and 20% or preferentially between 5% and 15%, even more preferentially between 10% and 15%.

The injection system SYS_I is configured to inject hot air from outside the oven 14.

In other words, the hot air source is external to oven 14.

The hot air injected is separate from the gases recirculated by the recirculation circuits of the combustion chambers 31-35.

In the embodiment shown in FIG. 2, the injection system SYS_I is configured to inject hot air into the recirculation circuits of each of the combustion chambers 31-35, more particularly at the inlet of said combustion chambers 31-35. This injection of hot air is symbolized in FIG. 2 by arrows F2.

The fact that hot air can be injected at the inlet to each of the combustion chambers 31-35, at the level of the recirculation circuits does not mean that this is the case on a permanent basis. For example, as shown in the embodiment shown in FIG. 2, the injection system SYS_I may include balancing valves 60 arranged between a hot air supply line 70 of the system SYS_I and said combustion chambers. Each balancing valve 60 is controllable, so as to allow a supply of hot air to a given combustion chamber 31-35, for example, for a given period of time. One or more balancing valves 60 can be controlled automatically (that is, programmed).

The inlet of hot air supply pipe 70 is in fluid communication with an exterior of oven 14.

The hot air supply duct 70 is configured to supply hot air from outside the oven 14.

Of course, it is also possible to envisage embodiments wherein one or more combustion chambers 31-35 are not connected to duct 70, so that they cannot be supplied with hot air from the system SYS_I.

In the embodiment shown in FIG. 2, in order to produce the hot air intended to be injected to replace a given fraction of hot air produced by a burner, the injection system SYS_I comprises electric heating means 80 configured to heat ambient air to a given temperature.

As a non-limiting example, said given temperature is between 350° C. and 1000° C., for example between 500° C. and 1000° C., more particularly between 700° C. and 800° C., even more particularly substantially equal to 750° C.

It should be noted here that the temperatures envisaged are much higher than the setting temperatures of the combustion chambers cited as an example above, so that taking into account the examples of injection fraction also cited above, the injection of hot air carried out by means of the system SYS_I can be seen as a low-volume thermal “boost” delivered to the combustion chambers 31-35.

The electric heating means 80 may, for example, comprise at least one electric battery with a power rating of between 100 kW and 900 kW, more particularly between 500 kW and 700 kW, for example substantially equal to 600 kW, said at least one battery making it possible to supply electricity, for example, to one or more electric resistances (not shown in the Figures) capable of heating the ambient air to the desired temperature.

In a more specific example, the number of electric batteries is equal to the number of heating chambers in oven 14.

It will be clear to the person skilled in the art that such electrical power values are not limiting to the invention. In the same way, the number of batteries used is not limitative of the invention, this number depending in particular on the temperature envisaged for the hot air injected but also on the volume/fraction of hot air to be taken into account, this last aspect being linked to the number of heating boxes intended to be connected, via their respective combustion chambers, to the SYS_I injection system.

Of course, to ensure that the hot air produced by the electric heating means 80 is delivered to the combustion chambers 31-35, the injection system SYS_I also includes air circulation means 90.

For example, and as shown in FIG. 2 in a non-limited manner, said air circulation means 90 comprise a fan 90 configured to circulate air in the hot air supply duct 70.

It should be noted that considering electric heating means 80 for generating hot air is only one variant of implementation of the invention. In this respect, other variants can still be envisaged for obtaining hot air, possibly in combination with the use of said electric heating means 80.

For example, it is possible to consider that the SYS_I injection system can be supplied with preheated air. At least some of the air preheated in this way may, for example, come from the melting furnace producing the molten glass for the fiberizing unit 1 (e.g., hot air from fumes produced by an air-gas furnace, an oxy-gas furnace, etc.) and/or may correspond to recovered hot air (e.g., air from one or more compressors and/or one or more exchangers arranged outside the oven 14, etc.). As a general rule, any preheated air derived from waste energy can be considered.

In the embodiment described here, and as shown in FIG. 2, the SYS_I injection system is also connected to an emergency hot air exhaust 100 (also known as an “emergency chimney”) positioned between said system SYS_I and said crosslinking oven 14. More specifically, and as shown in FIG. 2, the connection between the system SYS_I and the emergency evacuation 100 is made by means of an evacuation pipe 110 equipped with a balancing valve 120. Such a configuration is optional, and has the advantage, quite particularly (but not exclusively) when the system SYS_I is supplied with preheated air, of avoiding any heat build-up harmful to the operation of the SYS_C crosslinking system.

It should be noted that the invention does not only concern the SYS_C crosslinking system and the L_FAB manufacturing line. The invention also covers a method for crosslinking mat 12 using the SYS_C crosslinking system. Said crosslinking method includes steps for heating the mat 12 in each of the heating boxes 21-25, it being understood that all or part of these heating steps (depending on whether all or part of the heating boxes 21-25 are connected to the system SYS_I) are carried out by supplying hot air from the said system SYS_I.

Finally, the invention also covers a method of manufacturing the mat 12 implemented by the L_FAB manufacturing line. This manufacturing method includes in particular the first manufacturing steps already described above with reference to FIG. 1, as well as the steps implemented as part of the above-mentioned crosslinking method.

1. A crosslinking system for a continuous mat of mineral and/or plant fibers, comprising a crosslinking oven for said mat including at least one heating box, each heating box being connected to a combustion chamber, and an injection system arranged outside the crosslinking oven and configured to inject hot air into at least one combustion chamber of a heating box, the hot air thus injected replacing a given fraction of hot air produced by at least one burner attached to said at least one combustion chamber.

2. The crosslinking system according to claim 1, wherein said fraction is between 2% and 40%.

3. The crosslinking system according to claim 1, wherein the injection system comprises a heater configured to heat ambient air to a given temperature.

4. The crosslinking system according to claim 3, wherein said given temperature is between 350° C. and 1000° C.

5. The crosslinking system according to claim 3, wherein the heater comprises at least one electric battery whose power is between 100 kW and 900 kW.

6. The crosslinking system according to claim 1, wherein the injection system is supplied with preheated air.

7. The crosslinking system according to claim 6, wherein at least part of the preheated air comes from a glass melting furnace and/or corresponds to hot recovery air.

8. The crosslinking system according to claim 1, wherein the injection system is connected to a hot air emergency exhaust positioned between said injection system and said crosslinking oven.

9. The crosslinking system according to claim 1, wherein the injection system is configured to inject hot air from outside the crosslinking oven.

10. The crosslinking system according to claim 1, wherein the injection system comprises a hot air supply line arranged between a hot air source arranged outside the crosslinking oven and the at least one combustion chamber.

11. A manufacturing line for a continuous mat of mineral and/or plant fibers, comprising a fiberizing unit for a continuous mat of mineral and/or plant fibers, a conveyor for transporting the mat, and a crosslinking system according to claim 1.

12. A method for crosslinking a continuous mat of mineral and/or plant fibers, said method comprising crosslinking the continuous mat of mineral and/or plant fibers with the crosslinking system according to claim 1.

13. A method for manufacturing a continuous mat of mineral and/or plant fibers, said method comprising manufacturing the continuous mat of mineral and/or plant fibers by the manufacturing line according to claim 11.

14. The crosslinking system according to claim 2, wherein said fraction is between 5% and 30%.

15. The crosslinking system according to claim 14, wherein said fraction is between 5% and 20%.

16. The crosslinking system according to claim 3, wherein the heater is an electrical heater.

17. The crosslinking system according to claim 4, wherein said given temperature is between 500° C. and 1000° C.

18. The crosslinking system according to claim 17, wherein said given temperature is between 700° C. and 800° C.

19. The crosslinking system according to claim 5, wherein the power is between 500 kW and 700 kW.

20. The crosslinking system according to claim 19, wherein power is substantially equal to 600 kW.
